(19) United States
(12) Patent Application Publication
(10) Pub. No.: US 2018/0223488 A1
(43) Pub. Date: Aug. 9, 2018

(54) CLAMP HAVING MULTIPLE SIDE SURFACES

(71) Applicant: AMERICAN LOUVER COMPANY, Skokie, IL (US)

(72) Inventors: Scott Kitzerow, Lindenhurst, IL (US); Daniel Calby, Park Ridge, IL (US)

(21) Appl. No.: 15/425,330

(22) Filed: Feb. 6, 2017

(51) Int. Cl. E01F 9/688; G09F 7/18; F16M 13/02; F16M 11/38

(52) U.S. Cl. CPC E01F 9/688; G09F 7/18; G09F 2007/1817; F16M 11/38; G09F 2007/1856; F16M 13/022

(57) ABSTRACT

A clamping system includes a mast, a clamping body engageable with the mast, the clamping body including a plurality of side surfaces, a compressive member for compressing the mast and one of the plurality of side surfaces towards each other, and a vertical support member, the vertical support member disposable between the one of the plurality of side surfaces, the mast, a second of the plurality of side surfaces and a third of the plurality of side surfaces, the one of the plurality of side surfaces, the second of the plurality of side surfaces, the third of the plurality of side surfaces and the mast each facing a different side of the vertical support member when the vertical support member is disposed between the one of the plurality of side surfaces, the mast, the second of the plurality of side surfaces and the third of the plurality of side surfaces.

### TECHNICAL FIELD

The present disclosure generally relates to a mechanical attachment system. In particular, a clamping member is provided and includes a plurality of side surfaces.

### BACKGROUND

Standard sign stands are generally known in the art. Some sign stands include features such as folding legs for enhanced stability and storage properties, while others include various mounts for flexible or rigid signs. However, conventional mounting and clamping systems found on existing sign stands do not adequately address potential sign mount instability and potential rotation relative to a base or a sign mounting mast. Such conventional mounting and clamping systems result in component stress or sign stand failure when conventional sign mounts are faced with an impact, adverse weather conditions or repeated component manipulations. The accessories or integrated features available on these and other known sign stands do not safely and purposefully address these issues. The present disclosure seeks to overcome some limitations and other drawbacks of the prior art, and to provide new features not heretofore available. A full discussion of the features and advantages of the present disclosure is deferred to the following detailed description, which proceeds with reference to the accompanying drawings.

### SUMMARY

In some implementations of the present disclosure, a clamping system provides a mast, a clamping body engageable with the mast, the clamping body including a plurality of side surfaces, a compressive member for compressing the mast and one of the plurality of side surfaces towards each other, and a vertical support member, the vertical support member disposable between the one of the plurality of side surfaces, the mast, a second of the plurality of side surfaces and a third of the plurality of side surfaces, the one of the plurality of side surfaces, the second of the plurality of side surfaces, the third of the plurality of side surfaces and the mast each facing a different side of the vertical support member when the vertical support member is disposed between the one of the plurality of side surfaces, the mast, the second of the plurality of side surfaces and the third of the plurality of side surfaces.

In some implementations of the present disclosure, a clamping system provides a mast, a clamping body engageable with the mast, the clamping body including a plurality of side surfaces, a compressive member for compressing the mast and one of the plurality of side surfaces towards each other, and a vertical support member, the vertical support member disposable between the one of the plurality of side surfaces, the mast, a second of the plurality of side surfaces and a third of the plurality of side surfaces, the second of the plurality of side surfaces and the third of the plurality of side surfaces preventing a relative rotation between the mast and the vertical support member when the vertical support member is disposed between the one of the plurality of side surfaces, the mast, the second of the plurality of side surfaces and the third of the plurality of side surfaces.

In some implementations, the present disclosure provides a clamping system including a mast, a clamping body engageable with the mast, the clamping body including a plurality of side surfaces, a compressive member for compressing the mast and one of the plurality of side surfaces towards each other, and a vertical support member, the vertical support member disposable between the one of the plurality of side surfaces, the mast, a second of the plurality of side surfaces and a third of the plurality of side surfaces, the one of the plurality of side surfaces, the second of the plurality of side surfaces and the third of the plurality of side surfaces each facing a different side of the vertical support member when the vertical support member is disposed between the one of the plurality of side surfaces, the mast, the second of the plurality of side surfaces and the third of the plurality of side surfaces.

### BRIEF DESCRIPTION OF THE DRAWINGS

To understand the present disclosure, it will now be described by way of example, with reference to the accompanying drawings in which implementations of the disclosures are illustrated and, together with the descriptions below, serve to explain the principles of the disclosure.

FIG. 1 is a perspective view of a sign stand according to exemplary implementations of the present disclosure.

FIG. 2 is a side view of the sign stand of FIG. 1.

FIG. 3 is a perspective view of another implementation of a sign stand according to exemplary implementations of the present disclosure.

FIG. 4 is a side view of the sign stand of FIG. 3.

FIG. 5 is an exploded view of a clamping system according to exemplary implementations of the present disclosure.

FIG. 6 is a perspective view of a clamping system according to exemplary implementations of the present disclosure.

FIG. 7 is a cross-sectional view taken along line 7-7 of FIG. 6, showing a clamping system according to exemplary implementations of the present disclosure.

### DETAILED DESCRIPTION

While the clamping system discussed herein may be implemented in many different forms, the disclosure will show in the drawings, and will herein describe in detail, implementations with the understanding that the present description is to be considered as an exemplification of the principles of the sign stand and is not intended to limit the broad aspects of the disclosure to the implementations illustrated.

A sign stand 10 is commonly used to convey information, direct road traffic and alert road traffic to various conditions. Although often used in conjunction with road traffic, sign stands 10 can also be employed in industrial, construction and crowd-control applications. Enhancements to the stability, portability and/or visibility of such sign stands increase sign stand 10 utility.

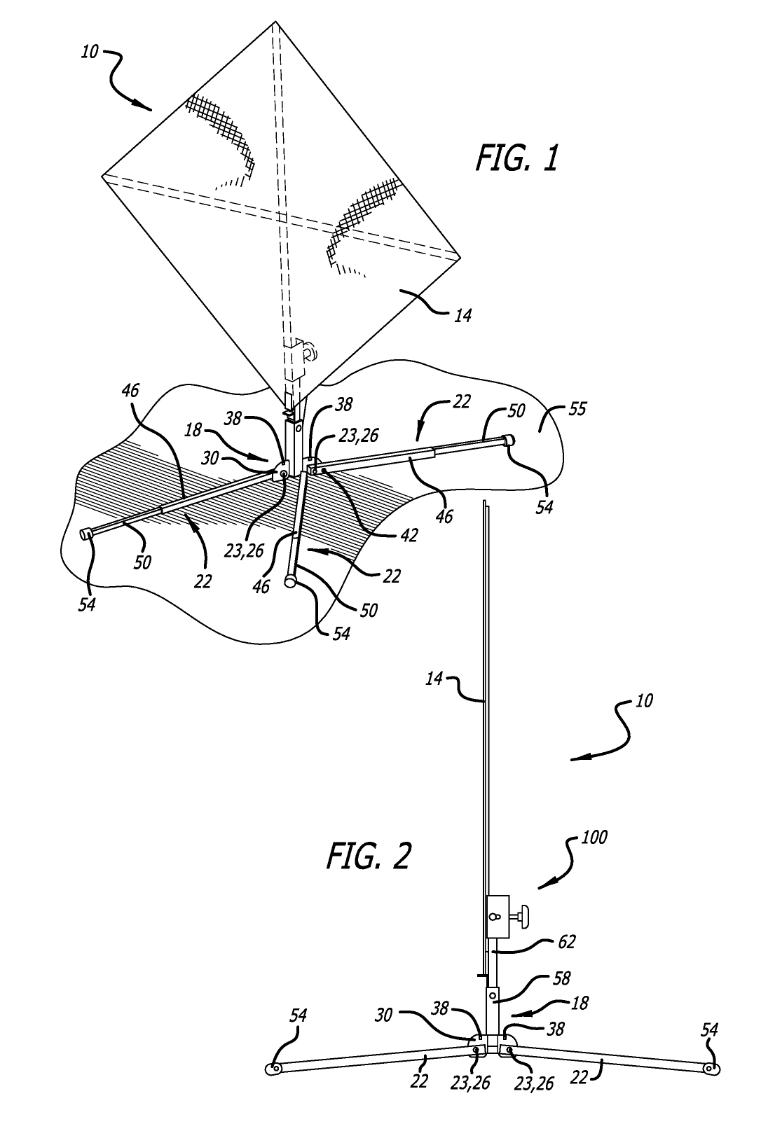

Referring now to the figures, and initially to FIGS. 1 and 2, in some implementations the sign stand 10 includes, and/or supports, a sign 14. The sign 14 can be rigid or flexible, and can include various colors, reflective materials, lights and messages. The sign stand 10 also includes a base 18 providing support for the sign stand 10. The base 18 includes a plurality of legs 22 pivotally attached to the base 18 at pivot points 23. Pivot elements 26, arranged at pivot points 23, enable the legs 22 to pivot relative to the base 18. Pivot points 23 may be disposed in, or on, leg mounting plates 30, which are attached to the base 18 and form portions of the base 18.

A leg locking system 34 is, in some implementations, disposed between at least one of the legs 22 and the base 18. The leg locking system 34 enables a leg 22 to selectively transition between, and lock in, deployed and folded positions. The leg locking system 34 includes a pin 42 selectively insertable into a recess 38 formed in the leg mounting plate 30. A deployed position, as shown in FIGS. 1 and 2, includes a distal leg segment 50 being disposed farther from the sign stand 10 than the distal leg segment 50 is in a folded position. Each of the legs 22 also includes a proximal leg segment 46, and the proximal leg segment 46 and distal leg segment 50 interface telescopically. The proximal leg segment 46 can telescope relative to the distal leg segment 50 to alter a total length of the leg 22. The deployed position allows each distal leg segment 50, via a foot 54, to contact a ground surface 55 while the folded position allows the sign stand 10 to be easily stored and transported due to a reduced volume.

A base tube 58 extends upwardly from the base 18 when the legs 22 are in a deployed position and the sign stand 10 is disposed on a ground surface 55. The base tube 58 supports a mast 62, and the base tube 58 and the mast 62 are, in some implementations, telescopically engaged.

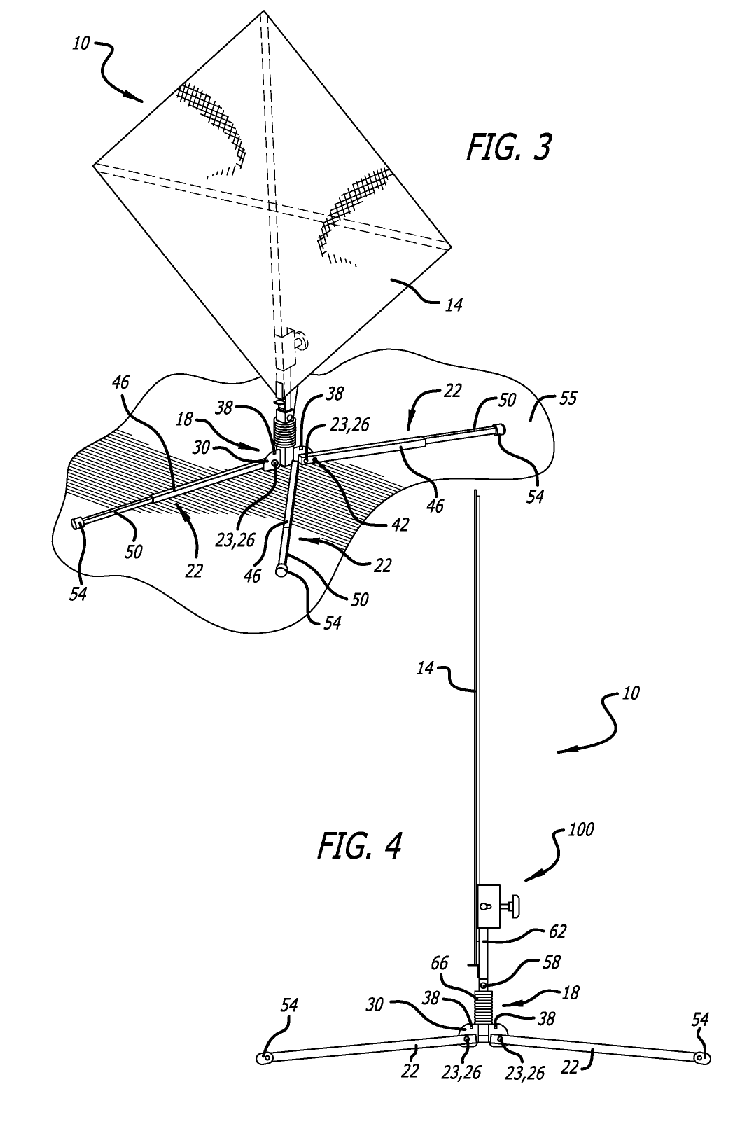

In some implementations, a spring element 66 is disposed between the base 18 and the base tube 58, as shown in FIGS. 3 and 4. The spring element 66 is, in some implementations, a coil spring. The spring element 66 serves to allow a degree of freedom between the base 18 and portions of the sign stand 10 located above the base 18, such as the sign 14 and a clamping system 100, which will be described below in further detail.

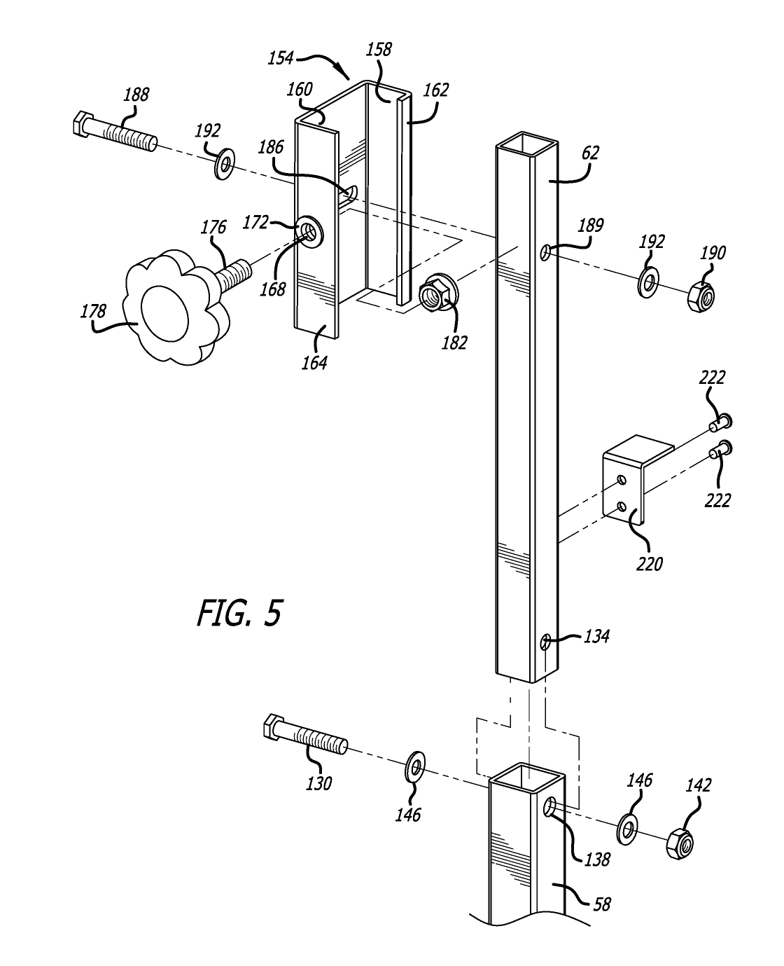

FIG. 5 is an exploded view of a clamping system 100 according to exemplary implementations of the present disclosure. Generally, the clamping system 100 according to exemplary implementations of the present disclosure supports the sign 14 when the sign 14 is mounted on the sign stand 10. The clamping system 100 securely, yet releasably, attaches a sign-supporting element to the sign stand 10 and prevents relative rotation between the sign 14, sign stand 10, elements of the clamping system 100 and other sign stand 10 components, which will be described below.

A mast bolt 130 secures the mast 62 to the base tube 58, as shown in FIG. 5. In detail, the mast bolt 130 passes through a mast lower bolt aperture 134 and a base tube upper aperture 138, which align when the mast 62 is telescopically inserted into the base tube 58. A mast bolt nut 142 and mast bolt washers 146 are cooperatively used with the mast bolt 130 to secure the mast 62 to the base tube 58 and minimize damage to any of the involved components.

FIG. 5 also shows a clamp body 154 including a first side surface 158, a second side surface 160, a third side surface 162 and a fourth side surface 164. In some implementations, adjoining side surfaces are disposed at substantially right angles to each other. In some implementations adjoining side surfaces are joined by a substantially right-angled corner, while in some implementations adjoining side surfaces are joined by a curved surface. The four side surfaces 158, 160, 162, 164 are integrally formed. Additionally, two of the side surfaces, for example the third side surface 162 and the fourth side surface 164, are separated by a gap in some implementations.

In detail, the fourth side surface 164 includes a compression aperture 168 concentrically lined with, and accepting, a compression grommet 172. The compression grommet 172, which is internally threaded in certain implementations, accepts a compression bolt 176, and the compression bolt 176 passes through the compression grommet 172 and compression aperture 168. One end of the compression bolt 176 includes a compression handle 178, which can be used to manually manipulate, or rotate, the compression bolt 176. Another end of the compression bolt 176 includes a compression applicator 182. As at least a portion of the compression bolt 176 is correspondingly threaded with the internal threading of the compression grommet 172, a rotation of the compression bolt 176, by the compression handle 178, moves the compression bolt 176 relative to the compression grommet 172 and the fourth side surface 164, as the fourth side surface 164 is substantially rigidly attached to the compression grommet 172. Thus, a rotation of the compression handle 178 in a first direction moves the compression applicator 182 away from the fourth side surface 164 and towards the first side surface 158, while a rotation of the compression handle 178 in a second direction, opposite from the first direction, moves the compression applicator 182 towards the fourth side surface 164 and away from the first side surface 158. The shape and/or size of the compression applicator 182 may enhance a frictional securement between the mast 62 and the compression applicator 182, and/or distribute loads across portions of the mast 62 and reduce a potential for damage to the mast 62.

The second side surface 160, which in some implementations is adjoined with the fourth side surface 164 and the first side surface 158, includes an alignment channel 186. The alignment channel 186 may extend along a similar axis as the compression bolt 176 when the compression bolt 176 is translated towards and away from the first side surface 158. An alignment bolt 188 passes through the alignment channel 186 and the mast 62 via alignment mast apertures 189. An alignment bolt nut 190 and one or more alignment bolt washers 192, along with the alignment bolt 188, removably, movably and/or fixedly secure the mast 62 to the second side surface 160. Such a securement also removably, movably and/or fixedly secures the mast 62 to the clamp body 154.

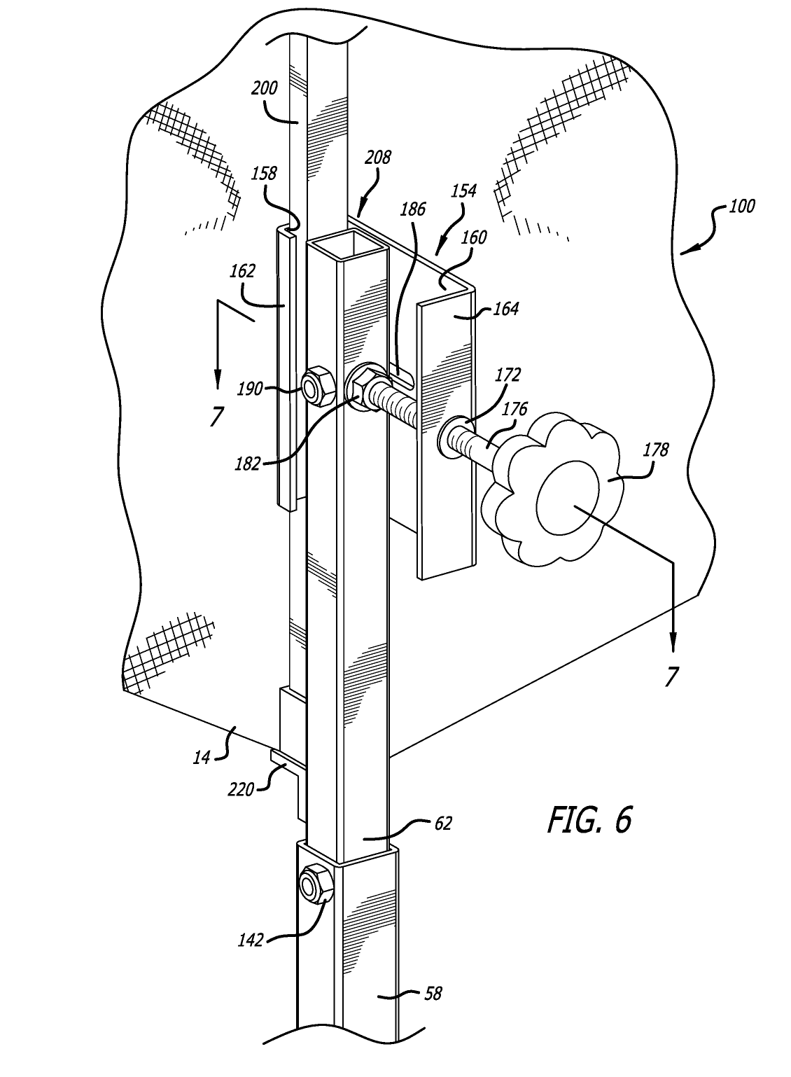

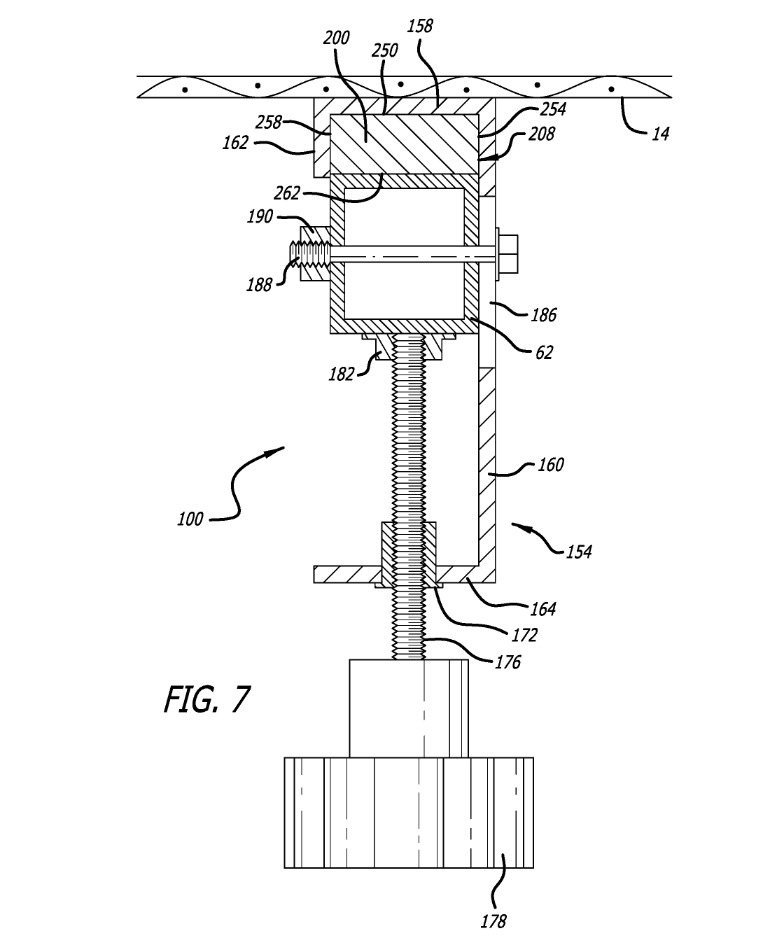

FIGS. 6 and 7 illustrate an assembled clamping system 100. In particular, FIG. 6 is a perspective view of the clamping system 100 according to exemplary implementations of the present disclosure. FIG. 7 is a cross-sectional view taken along line 7-7 of FIG. 6, showing a clamping system 100 according to exemplary implementations of the present disclosure.

Turning to FIG. 6, the clamping system 100 is shown in a possible assembled arrangement. As can be seen, the compression bolt 176 is disposed within the compression grommet 172 and the compression applicator 182 is disposed on an opposite side of the fourth side surface 164 from the compression handle 178. The compression applicator 182 is shown as being near, or in contact with, the mast 62. Further, a vertical support element 200 is disposed within an area at least partially defined by the clamp body 154. In some implementations, the vertical support element 200 is disposed within an area at least partially bounded by the first, second and third side surfaces 158, 160, 162.

The vertical support element 200, in some implementations, and as best shown in FIG. 7, includes a first vertical support element side 250, a second vertical support element side 254, a third vertical support element side 258 and a fourth vertical support element side 262. Further, in some implementations, the second vertical support element side 254 is opposite the third vertical support element side 258, and/or the first vertical support element side 250 is opposite the fourth vertical support element side 262. In certain implementations, the second side surface 160 and the third side surface 162 are spaced apart by a distance corresponding to, or approximately, a width of the first vertical support element side 250.

A tab 220 is, in some implementations, attached to the mast 62 by rivets 222 as shown in FIGS. 5 and 6. The tab 220 supports a lower portion of the vertical support element 200, thus enhancing the stability and securement of the vertical support element 200 relative to the clamping system 100. In certain implementations, such as those shown in FIGS. 1-4, a horizontal support element 204 is attached to the vertical support element 200 and helps to support the sign 14 on the sign stand 10. The vertical and horizontal support elements 200, 204 each attach to the sign 14 at or near corners of the sign 14.

In some implementations, the first side surface 158 is disposed on an opposite side of the vertical support element 200 than is the mast 62 when the vertical support element 200 is disposed between the first side surface 158, second side surface 160, third side surface 162 and the mast 62.

In some implementations, the first side surface 158, second side surface 160 and third side surface 162 each face a different side of the vertical support element 200 when the vertical support element 200 is disposed between the first side surface 158, second side surface 160, third side surface 162 and the mast 62.

In some implementations, the first side surface 158, second side surface 160 and third side surface 162 each contact a different side of the vertical support element 200 when the vertical support element 200 is disposed between the first side surface 158, second side surface 160, third side surface 162 and the mast 62.

In some implementations, the first side surface 158, second side surface 160 and third side surface 162 and the mast 62 each face a different side of the vertical support element 200 when the vertical support element 200 is disposed between the first side surface 158, second side surface 160, third side surface 162 and the mast 62.

In some implementations, the first side surface 158, second side surface 160 and third side surface 162 and the mast 62 each contact a different side of the vertical support element 200 when the vertical support element 200 is disposed between the first side surface 158, second side surface 160, third side surface 162 and the mast 62. Further, in some implementations, one or more of the side surfaces 158, 160, 162, 164 does not extend an entire length or width of the clamp body 154.

In operation, the mast 62 is placed within an area of the clamp body 154 which, in some implementations, is bounded by the first, second, third and fourth side surfaces 158, 160, 162, 164. The vertical support element 200 is disposed in an area of the clamp body 154 which, in some implementations, is bounded by the first, second and third side surfaces 158, 160, 162. The mast 62 is then placed into contact with the vertical support element 200, such that the vertical support element 200 is substantially within a channel 208 formed by the first, second and third side surfaces 158, 160, 162 and the mast 62. Through manual manipulation of the compression handle 178, the compression bolt 176 is moved towards the mast 62 such that the compression applicator 182 is placed in contact with the mast 62. Continued manipulation of the compression applicator 182 presses the mast 62 into the vertical support element 200, releasably securing the vertical support element within the channel 208 formed by the first, second and third side surfaces 158, 160, 162 and the mast 62. As the vertical support element 200 is compressed between the mast 62 and various side surfaces of the clamp body 154, the vertical support element 200 becomes releasably secured relative to the sign stand 10 and mast 62. Further, the compression of the vertical support element 200 between the mast 62 and the first side surface 158, and/or the second side surface 160 and the third side surface 162 of the clamp body 154 facing or being in contact with opposed sides of the vertical support element 200, prevents or hinders a relative rotation between the mast 62 and the vertical support element 200 when the vertical support element 200 is disposed between the mast 62 and the first, second and third side surfaces 158, 160, 162. Such an arrangement also protects portions of the vertical support element 200 from damage and weathering, and further may enhance grip between the clamp body 154 and the vertical support element 200 and/or between the mast 62 and the vertical support element 200.

While some implementations have been illustrated and described, numerous modifications come to mind without significantly departing from the spirit of the disclosure, and the scope of protection is only limited by the scope of the accompanying claims. Further, the present disclosure provides a sign base and a sign assembly having increased structural strength, improved aesthetic design, a footprint facilitating flexible sign base placement and a wheel arrangement allowing easy sign assembly transportation.

The disclosed systems and methods are well adapted to attain the ends and advantages mentioned as well as those that are inherent therein. The particular implementations disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative implementations disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A clamping system, comprising:
a mast;
a clamping body engageable with the mast, the clamping body including a plurality of side surfaces;
a compressive member for compressing the mast and one of the plurality of side surfaces towards each other; and
a vertical support member, the vertical support member disposable between the one of the plurality of side surfaces, the mast, a second of the plurality of side surfaces and a third of the plurality of side surfaces, the one of the plurality of side surfaces, the second of the plurality of side surfaces, the third of the plurality of side surfaces and the mast each facing a different side of the vertical support member when the vertical support member is disposed between the one of the plurality of side surfaces, the mast, the second of the plurality of side surfaces and the third of the plurality of side surfaces.

2. The clamping system of claim 1, wherein the one of the plurality of side surfaces, the second of the plurality of side surfaces, the third of the plurality of side surfaces and the mast each contact a different side of the vertical support member when the vertical support member is disposed between the one of the plurality of side surfaces, the mast, the second of the plurality of side surfaces and the third of the plurality of side surfaces.

3. The clamping system of claim 1, wherein the one of the plurality of side surfaces and the mast are disposed on opposing sides of the vertical support member when the vertical support member is disposed between the one of the plurality of side surfaces, the mast, the second of the plurality of side surfaces and the third of the plurality of side surfaces.

4. The clamping system of claim 1, wherein the second of the plurality of side surfaces and the third of the plurality of side surfaces are substantially opposed surfaces.

5. The clamping system of claim 1, wherein the vertical support member supports a sign.

6. The clamping system of claim 1, wherein the compressive member includes a threaded section and a handle for manual manipulation.

7. A clamping system, comprising:
a mast;
a clamping body engageable with the mast, the clamping body including a plurality of side surfaces;
a compressive member for compressing the mast and one of the plurality of side surfaces towards each other; and
a vertical support member, the vertical support member disposable between the one of the plurality of side surfaces, the mast, a second of the plurality of side surfaces and a third of the plurality of side surfaces, the second of the plurality of side surfaces and the third of the plurality of side surfaces preventing a relative rotation between the mast and the vertical support member when the vertical support member is disposed between the one of the plurality of side surfaces, the mast, the second of the plurality of side surfaces and the third of the plurality of side surfaces.

8. The clamping system of claim 7, wherein the one of the plurality of side surfaces and the mast are disposed on opposing sides of the vertical support member when the vertical support member is disposed between the one of the plurality of side surfaces, the mast, the second of the plurality of side surfaces and the third of the plurality of side surfaces.

9. The clamping system of claim 7, wherein the second of the plurality of side surfaces and the third of the plurality of side surfaces are substantially opposed surfaces.

10. The clamping system of claim 7, wherein the one of the plurality of side surfaces, the second of the plurality of side surfaces, the third of the plurality of side surfaces and the mast each contact a different side of the vertical support member when the vertical support member is disposed between the one of the plurality of side surfaces, the mast, the second of the plurality of side surfaces and the third of the plurality of side surfaces.

11. The clamping system of claim 7, wherein the mast is connected to a base.

12. The clamping system of claim 11, wherein the base includes a plurality of folding legs.

13. The clamping system of claim 11, wherein a coil spring is disposed between the mast and the base.

14. The clamping system of claim 7, wherein the vertical support member supports a sign.

15. The clamping system of claim 7, wherein the compressive member includes a threaded section and a handle for manual manipulation.

16. The clamping system of claim 7, wherein the vertical support member supports a sign.

17. The clamping system of claim 16, wherein a horizontal support member is attached to the vertical support member, and the sign is supported by both of the horizontal support member and the vertical support member.

18. A clamping system, comprising:
a mast;
a clamping body engageable with the mast, the clamping body including a plurality of side surfaces;
a compressive member for compressing the mast and one of the plurality of side surfaces towards each other; and
a vertical support member, the vertical support member disposable between the one of the plurality of side surfaces, the mast, a second of the plurality of side surfaces and a third of the plurality of side surfaces, the one of the plurality of side surfaces, the second of the plurality of side surfaces and the third of the plurality of side surfaces each facing a different side of the vertical support member when the vertical support member is disposed between the one of the plurality of side surfaces, the mast, the second of the plurality of side surfaces and the third of the plurality of side surfaces.

19. The clamping system of claim 18, wherein the one of the plurality of side surfaces, the second of the plurality of side surfaces and the third of the plurality of side surfaces each contact a different side of the vertical support member when the vertical support member is disposed between the one of the plurality of side surfaces, the mast, the second of the plurality of side surfaces and the third of the plurality of side surfaces.

20. The clamping system of claim 18, wherein the one of the plurality of side surfaces and the mast are disposed on opposing sides of the vertical support member when the vertical support member is disposed between the one of the plurality of side surfaces, the mast, the second of the plurality of side surfaces and the third of the plurality of side surfaces.

21. A clamping system for removably attaching a mast to a vertical support member, said clamping system comprising:
a clamp body having a plurality of side surfaces formed to engage at least three sides of said vertical member and at least one side of said mast; and
a threaded bolt assembly extending from said clamp body and engageable with another side of said mast to compress said mast against said vertical member.
